(19) United States
(12) Patent Application Publication
(10) Pub. No.: US 2026/0235178 A1
(43) Pub. Date: Aug. 13, 2026

(54) DRUM BRAKE APPARATUS FOR ELECTRIC VEHICLE, AND ELECTRIC VEHICLE WITH THE DRUM BRAKE APPARATUS

(71) Applicant: Schaeffler Technologies AG & Co. KG, Herzogenaurach (DE)

(72) Inventors: Doris Maria Wimmer, Ottenhöfen (DE); Marc Finkenzeller, Gengenbach (DE); David Stringfellow, Ettlingen (DE)

(73) Assignee: Schaeffler Technologies AG & Co. KG, Herzogenaurach (DE)

(21) Appl. No.: 19/471,636

(22) PCT Filed: Feb. 1, 2024
(86) PCT No.: PCT/DE2024/100082

§ 371 Date: Oct. 1, 2025

(30) Foreign Application Priority Data
Apr. 4, 2023 (DE) 10 2023 108 652.9

(51) Int. Cl. F16D 65/833; F16D 65/02

(52) U.S. Cl. CPC F16D 65/833; F16D 2065/1328

(57) ABSTRACT

A drum brake includes a brake drum device, a brake device and a cooling device. The brake drum device forms a brake chamber and includes a brake drum with an inner circumference. The brake device includes brake shoes and is arranged to press the brake shoes against the inner circumference to generate a braking torque by converting kinetic energy into heat energy. The cooling device includes a fluid chamber and a cooling fluid arranged in the fluid chamber for transporting the heat energy. The brake drum device is arranged in the fluid chamber and fluid-tight relative to an environment.

### CROSS-REFERENCE TO RELATED APPLICATIONS

This application is the United States National Phase of PCT Appln. No. PCT/DE2024/100082 filed Feb. 1, 2024, which claims priority to German Application No. DE 102023108652.9 filed Apr. 4, 2023, the entire disclosures of which are incorporated by reference herein.

### TECHNICAL FIELD

The present disclosure relates to a brake apparatus for an electric vehicle. The disclosure also relates to an electric vehicle with the drum brake apparatus.

### BACKGROUND

Braking systems are commonly used in vehicles to slow them down in traffic. Disc brake systems are often used, but drum brake systems are also used as an alternative, particularly on the rear wheels. Drum brake systems have a brake drum, and the brake drum is closed at least in the direction of rotation and forms a straight cylindrical surface as a counter surface to a friction lining. Due to the closed counter surface, cooling of a drum brake system is more difficult than cooling of a disc brake system, which has a free-running counter surface.

For the effective cooling of a drum brake system, the document CN 206582258 U, proposes a drum brake with a circumferential water jacket wall adjacent to the counter surface, and cooling liquid can be transported in the water jacket wall in order to actively cool the brake drum.

### SUMMARY

The present disclosure provides a drum brake apparatus for an electric vehicle with a high level of environmental awareness.

The present disclosure relates to a drum brake apparatus which is in particular suitable and/or designed for an electric vehicle. The electric vehicle can be designed as a pure electric vehicle; alternatively, it can be realized as a hybrid vehicle. In particular, the electric vehicle is designed as a passenger car, truck, and/or bus. Specifically, the electric vehicle is designed as a BEV (battery electric vehicle).

The drum brake apparatus has a brake drum device, and the brake drum device forms a brake chamber. The brake drum device in particular includes a brake drum, and the brake drum may have a straight inner cylinder surface on the inner circumference, which forms a braking surface. The brake drum device forms a rotating braking partner of the drum brake apparatus.

Furthermore, the drum brake apparatus has a brake device, and the brake device has brake shoes which can be pressed in particular in a frictional manner against the braking surface of the brake drum device, in particular the brake drum. The brake device in particular has a brake actuator which makes it possible to press the brake shoes against the brake drum device in the radial direction in relation to a main axis of rotation. At least the brake shoes are arranged in the brake chamber. During the frictional contact between the brake shoes and the braking surface of the brake drum device, a braking torque is generated, and kinetic energy, in particular of the electric vehicle, is converted into heat energy, which is initially present in the drum brake apparatus.

The drum brake apparatus has a cooling device for transporting away the heat energy generated during the conversion of kinetic energy into heat energy via a cooling fluid. The cooling fluid can be a water-based cooling fluid or an oil-based cooling fluid, in particular a gear oil.

The cooling device may form a fluid chamber, and the cooling fluid may be arranged in particular openly in the fluid chamber. The fluid chamber can be partially or completely and/or permanently or only temporarily filled with the cooling fluid.

The brake drum device is arranged in the fluid chamber so that, on the one hand, the brake drum device is cooled by the cooling fluid. On the other hand, the arrangement of the brake chamber in the fluid chamber ensures that the brake chamber is fluid-tight and thus also dust-tight in relation to the environment of the drum brake apparatus. In particular, the brake drum device and/or the brake chamber is arranged encapsulated in the fluid chamber and/or in the cooling device.

The cooling device can be used, in addition to cooling, to reliably prevent brake dust particle emissions from the drum brake apparatus into the environment. While purely mechanical covers of drum brakes have the disadvantage that, due to the fact that the drum brakes each have a stationary and a rotating section, there are transition areas between the sections through which brake dust particles can escape into the environment as emissions.

In contrast, the present disclosure provides that the brake drum device and thus the actual brake chamber in which the brake dust particles are generated is encapsulated in the fluid chamber, and the fluid chamber must even be sealed fluid-tight from the environment due to the cooling fluid. On the one hand, it ensures that no brake dust particles can get from the brake chamber into the fluid chamber. In the unlikely event that this does happen, the brake dust is trapped in the cooling fluid of the fluid chamber and cannot escape into the environment. This ensures that the drum brake apparatus is designed in an environmentally friendly manner.

In addition, future laws may limit particulate matter pollution from automobiles. The present disclosure provides a solution to prevent the emission of brake dust particles into the environment and, optionally, at the same time, by utilizing the waste heat from the brakes, i.e. the heat energy, to extend the range/increase the efficiency of the electric vehicle.

In an example embodiment, the drum brake apparatus is designed as a dry brake apparatus. Thus, a fluid-tight seal is arranged between the brake chamber and the fluid chamber, so that the fluid-tight seal already reliably prevents the transfer of brake dust from the brake chamber into the fluid chamber.

In an example embodiment, the drum brake apparatus has a connection axle for connecting the brake device to a stationary braking partner. For example, the brake device can be connected to a chassis of the electric vehicle via the connection axle. The brake drum is rotatably mounted relative to the connection axle and in particular on the connection axle and is sealed fluid-tight by a first sealing device. The brake drum device forms a first sealing partner and the connection axle forms a second sealing partner, so that the brake chamber is sealed fluid-tight and thus also dust-tight from the fluid chamber by the first sealing device.

In an example embodiment, the drum brake apparatus has a connection shaft for connecting the brake drum device to a rotating braking partner. The rotating braking partner can form part of the electric vehicle's drive train. However, it can also be provided that the rotating braking partner is a wheel or a shaft of a passive axle of the electric vehicle. The cooling device is rotatably mounted relative to the connection shaft and in particular on the connection shaft. The cooling device is sealed fluid-tight by a second sealing device, and the cooling device forms a first sealing partner and the connection shaft forms a second sealing partner, so that the fluid chamber is sealed fluid-tight from the environment by the second sealing device.

The drum brake apparatus may be designed as an end section and/or as a termination of a torque path into the drum brake apparatus. In particular, an applied drive torque is not passed through the drum brake apparatus. Alternatively or additionally, the drum brake apparatus is only connected on one side to a or the torque path.

In principle, the sealing devices can be designed as contactless seals. These may be implemented as contacting and/or touching seals so that the sealing effect is improved.

It is intended that the shortest and/or only brake dust particle path from the brake chamber into the environment leads via the first sealing device into the fluid chamber and subsequently via the second sealing device into the environment. Along the brake dust particle path, the brake dust is thus protected from transferring into the environment via the two sealing devices and the cooling fluid in the fluid chamber.

In an example embodiment, the brake drum device has a brake drum and a brake drum cover. The brake drum and the brake drum cover form a drum housing for the brake chamber. In particular, the brake drum is cup-shaped, and the braking surface is arranged on the inner circumference of a radially circumferential cup wall of the brake drum. In a radial plane to the main axis of rotation, the brake drum has a particularly closed drum base. The brake drum may be formed in one piece and/or from a common material section. The brake drum is connected to the connection shaft in a rotationally fixed manner, particularly at the drum base. The drum housing is rotatably mounted relative to the connection axle via the drum cover, and the drum housing is closed except for the passage for the connection axle and is thus fluid-tight. This means that brake dust can only escape from the brake chamber via the first sealing arrangement, if at all.

In an example embodiment, the cooling device has a cooling housing with the fluid chamber. The cooling housing is arranged stationary with the connection axle. The cooling housing and the connection axle may be firmly connected to one another and, in particular, in a statically fluid-tight manner. The connection shaft is rotatably mounted relative to the cooling housing and in particular in the cooling housing. The cooling housing is designed to be statically fluid-tight to the outside and/or the environment, except for the passage for the connection shaft. Statically fluid-tight means in particular that there are no transitions with sections moving towards each other.

The cooling housing may have a fluid supply and a fluid discharge for the cooling fluid.

In one possible design embodiment, the fluid supply and/or the fluid discharge is designed as an interface in the cooling housing. For example, a hose or pipe can be attached to the respective interface and/or are designed as a hose, pipe, or flange.

In an example embodiment, the connection shaft has a fluid passage for the axial passage of the cooling fluid, wherein the fluid passage is fluidically connected to the fluid chamber. For example, the connection shaft has an annular gap space, and the annular gap space forms the fluid passage. In this embodiment, the cooling fluid, for example as oil, in particular as gear oil, can be passed from an adjacent electric axle or an electric motor through the connection shaft into the fluid chamber.

A further subject matter of the disclosure relates to an electric vehicle having the drum brake apparatus previously described. The drum brake apparatus can be arranged close to a driven or non-driven wheel of the electric vehicle. Alternatively, the drum brake apparatus is integrated into the drive train and may be arranged in the direction of torque flow in front of a differential and/or a transmission gear.

The electric vehicle optionally has a thermal management arrangement, the thermal management arrangement has at least one consumer, and the thermal management arrangement is designed to supply the heat energy from the drum brake apparatus to the consumer. In this design, the dissipated heat energy is not simply discharged into the environment, but rather an attempt is made to use the heat energy at the consumer in order to improve the environmental balance and efficiency of the electric vehicle. For example, the consumer can be designed as a heater, a preheater of a transmission and/or of an engine, etc.

The electric vehicle may have a recuperation device for recuperating electrical energy from the kinetic energy, and the thermal management arrangement may be designed to adjust the distribution of the absorption of the kinetic energy between the drum brake apparatus and the recuperation device depending on a temperature state, in particular of the electric vehicle and/or the environment. The focus here is on the fact that, especially in cold outside temperatures, intermediate storage of kinetic energy as electrical energy and possibly subsequently converted back into heat energy by a consumer, e.g., for heating the interior of the electric vehicle, is not energy efficient. Rather, the thermal management arrangement may direct the kinetic energy to the drum brake apparatus, which converts the kinetic energy into heat energy, and the converted heat energy is supplied directly to the consumer via the thermal management arrangement.

It is therefore proposed to install a supplementary braking system on the drive train or on an axle without a drive. This braking system supplements the recuperation of the electric motor in driving situations where it cannot or should not absorb the full braking energy. These are, for example, driving situations with low speed/rotational speed or stopping to a standstill or braking processes at low temperatures.

Here, the braking energy can be transferred in the form of heat to the thermal management system (without having to store the energy in the battery in the meantime). In addition, brake dust particles are not released into the environment.

This special arrangement is a drum brake system that has a housing around the drum that forms an enclosed space with the outer surface of the brake drum via two bearing devices. If necessary, cooling fluid is supplied to this space, which absorbs heat via the brake drum heated by braking energy and passes it on to the thermal management of the electric axle and/or the electric vehicle. The actuation/actuator system and the bearing and torque support of the brake shoes are guided through the interior of one of the two support bearings.

The brake drum device provides, in particular, that the rotating brake drum forms a closed brake chamber with the aid of a brake drum cover. The cooling housing, which also has a cover and forms a second closed space, the fluid chamber, is located around the brake drum device. This second closed space is traversed by cooling fluid, which is fed into the space through a coolant supply and is discharged again at a suitable location (e.g., at the lowest point of the housing) via a coolant outlet. To prevent coolant from entering the brake drum, the space at the transition to the rotating parts is sealed by means of a seal (e.g., grooved sealing rings). The arrangement is supported by two support bearings, which can be located either in the dry or wet chamber. The sealing is then arranged differently accordingly (groove seals to the left of the bearing-->grease-lubricated bearings/groove seals to the right of the bearing-->oil-lubricated bearings).

The brake shoes, to which the friction linings are attached, are located inside the brake drum and thus the brake chamber and are pressed against the inner surface of the brake drum as the braking surface by means of an actuating unit as a brake actuator. The brake torque support and the hydraulic or electromechanical supply line to the actuation unit are guided into the interior of the brake drum via a cylindrical geometry as a connection axle so that it can be sealed well.

The second chamber, the fluid chamber, can be completely flooded with coolant or only in sections. An alternative arrangement uses the existing cooling volume flow that cools the electric motor, e.g., an oil cooling system. This is guided by the rotating shaft as a connection shaft towards the drive from the electric motor into the brake drum. This has cooling channels with an outlet on the outer surface of the brake drum. Due to centrifugal force, the coolant is directed into the second closed space as a fluid chamber and there, at a suitable location, there is a coolant outlet from which the coolant is transported to the thermal management.

The arrangements use the coolant for thermal management and transfer heat generated by mechanical friction work to the thermal management.

### BRIEF DESCRIPTION OF THE DRAWINGS

Further features, advantages and effects of the disclosure result from the following description of exemplary embodiments and the attached figures. In the figures:

FIG. 1 shows a schematic representation of a drum brake apparatus as an exemplary embodiment;

FIG. 2 shows the drum brake apparatus in FIG. 1 with partially graphically hidden components, but with a fluid supply and a fluid discharge for a cooling fluid;

FIG. 3 shows a schematic representation of a drum brake apparatus as a further exemplary embodiment;

FIG. 4 shows a schematic block diagram of the electric vehicle with a thermal management arrangement.

### DETAILED DESCRIPTION

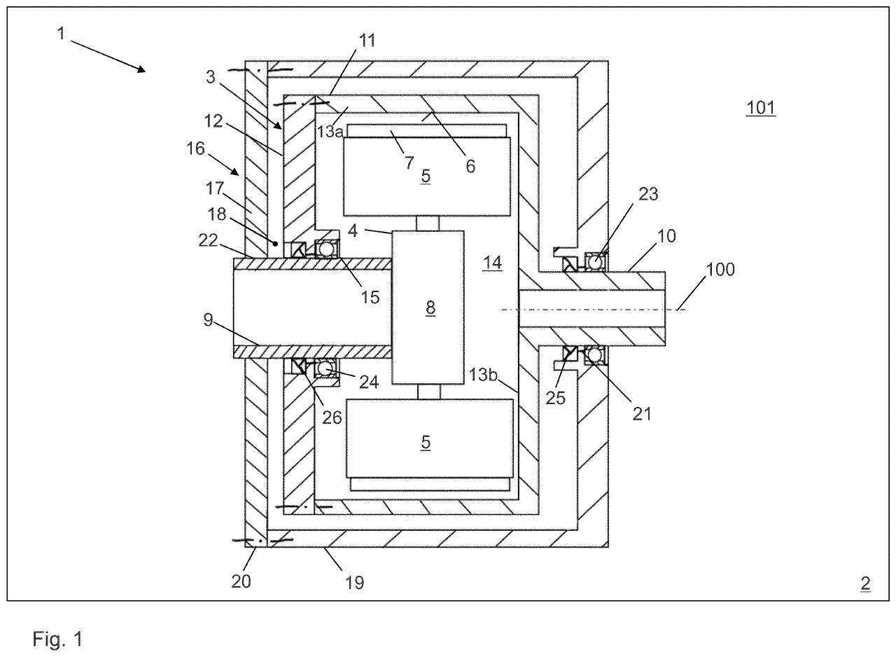

FIG. 1 shows a drum brake apparatus 1 for an electric vehicle 2 in a schematic longitudinal section along a main axis 100. The electric vehicle 2 is shown only very schematically in FIG. 1.

The drum brake apparatus 1 can be arranged, for example, for braking non-driven wheels in the electric vehicle 2. Alternatively, it is connected to the drive train of the electric vehicle 2 via transmission technology. In particular, the drum brake apparatus 1 can be arranged in the opposite direction of the drive torque flow behind a differential device and/or a transmission device of the electric vehicle 2.

The drum brake apparatus 1 is designed as an end section or as a terminal section, and a torque path runs into the drum brake apparatus 1 and ends there in every operating state of the drum brake apparatus 1.

The drum brake apparatus 1 has a brake drum device 3 and a brake device 4, and the brake device 4 is arranged at least in sections in the brake drum device 3. The brake device 4 has brake shoes 5, which can be pressed in the radial direction to the main axis 100 against a braking surface 6 of the brake drum device 3. The braking surface 6 is formed as a straight cylindrical surface on the inner circumference of the brake drum device 3. Optionally, friction linings 7 are arranged on the brake shoes 5, which can press against the braking surface 6. Alternatively, the friction linings 7 are integrated into the brake shoes 5.

The brake device 4 has a brake actuator 8, and the brake actuator 8 is designed to move the brake shoes 5 for braking in the radial direction in relation to the main axis of rotation 100. The brake actuator 8 can be designed as a mechanical, electrical, and/or magnetic brake actuator 8.

The brake device 4 is arranged stationary in the electric vehicle 2 via a connection axle 9. The connection axle 9 can have any shape in cross-section, but it may have a circular cross-section and be realized as a hollow axle. The brake actuator 8 can be actuated by the connection axle 9 or the braking force can be introduced into the brake device 4 in another way. The brake device 4 thus forms a stationary braking partner of the drum brake apparatus 1.

The brake drum device 3 is connected to a connection shaft 10 in a rotationally fixed manner. The connection shaft 10 can-as already described-be operatively connected to the drive train and/or driven or non-driven wheels of the electric vehicle 2. The brake drum device 3 thus forms a rotating partner of the drum brake apparatus 1.

The brake drum device 3 has a brake drum 11 and a brake drum cover 12. The brake drum 11 is designed as a pot, which in the longitudinal section shown has a horizontal U-shaped form. The braking surface 6 is arranged on the inner circumference of a circumferential radial wall 13a of the brake drum 11. The radial wall is integrally connected to a drum base 13b. The connection shaft 10 is integrally formed on the drum base 13b. The brake drum cover 12 closes off a brake chamber 14 from the brake drum 11, and the brake drum 11 and brake drum cover 12 form a drum housing for the brake chamber 14.

The drum base 13b may be closed. In particular, the brake chamber 14 is opened exclusively through an inner axle passage opening 15 for the passage of the connection axle 9.

The drum brake apparatus 1 has a cooling device 16, and the cooling device 16 is designed to transport away the heat energy converted during a braking operation in the drum brake apparatus 1 by converting kinetic energy into heat energy via a cooling fluid. The cooling device 16 is formed by a cooling housing 17, and a fluid chamber 18 for the cooling fluid is arranged in the cooling housing 17.

The cooling device 17 has a cooling pot 19 and a cooling cover 20, which together form the cooling housing 18. The cooling pot 19 can be circular in cross section. For example, at the fluid chamber 18 is circular and arranged coaxially and/or concentrically to the brake drum device 3. The cooling pot 19 is closed by the cooling cover 20, and the cooling cover 20 extends in a radial plane to the main axis of rotation 100. The cooling housing 17 has a shaft passage opening 21 for the connection shaft 10. Furthermore, the cooling housing 17 has an outer axle passage opening 22 for the connection axle 9. The connection axle 9 and the connection shaft 10 are arranged coaxially in this embodiment.

The connection shaft 10 is mounted relative to the cooling housing 17 via a first bearing device 23. The brake drum device 3 is mounted relative to the connection axle 9 via a second bearing device 24.

A first sealing device 25 is arranged between the cooling housing 17 and the connection shaft 10, and the connection shaft 9 forms a first sealing partner and the cooling housing 17 forms a second sealing partner. A second sealing device 26 is arranged between the brake drum device 3 and the connection axle 9, and the brake drum device 3 forms a first sealing partner and the connection axle 9 forms a second sealing partner. With the first sealing device 25, the fluid chamber 18 is sealed fluid-tight against an environment 101, so that the cooling fluid from the fluid chamber 18 cannot pass through the shaft passage opening 21.

While the bearing devices 23, 24 are each arranged on a dry side and the sealing devices 25, 26 are each arranged on a fluid side, these can also be swapped in position or bearing devices with integrated sealing devices could also be used.

With the second sealing arrangement 26, the brake chamber 14 is separated fluid-tight from the fluid chamber 18, so that no cooling fluid can pass from the fluid chamber 18 into the brake chamber 14. The brake chamber 14 is designed as a dry brake chamber in which, in particular, no cooling fluid is present. Although the connection shaft 10 is designed as a hollow shaft, it may be fluidically closed so that the brake chamber 14 is also fluidically closed in the direction of the connection shaft 10.

Thus, the brake chamber 14 is arranged in the fluid chamber 18 so that, firstly, no brake dust can escape from the brake chamber 14 via the second sealing arrangement 26. Secondly, any brake dust could only enter the fluid chamber 18 when overcoming the second sealing device 26, so that the brake dust would be immediately bound by the cooling fluid. Even if the cooling fluid could not bind the brake dust, a further barrier would be created by the first sealing device 25. A possible brake dust path would thus run from the brake chamber 14, in which the brake dust is generated by the braking process, via the second sealing device 26 as a first barrier, via the fluid chamber 18 as a second barrier and subsequently via the first sealing device 25 as a third barrier, so that escape of brake dust from the drum brake apparatus 1 into the environment 101 is unlikely.

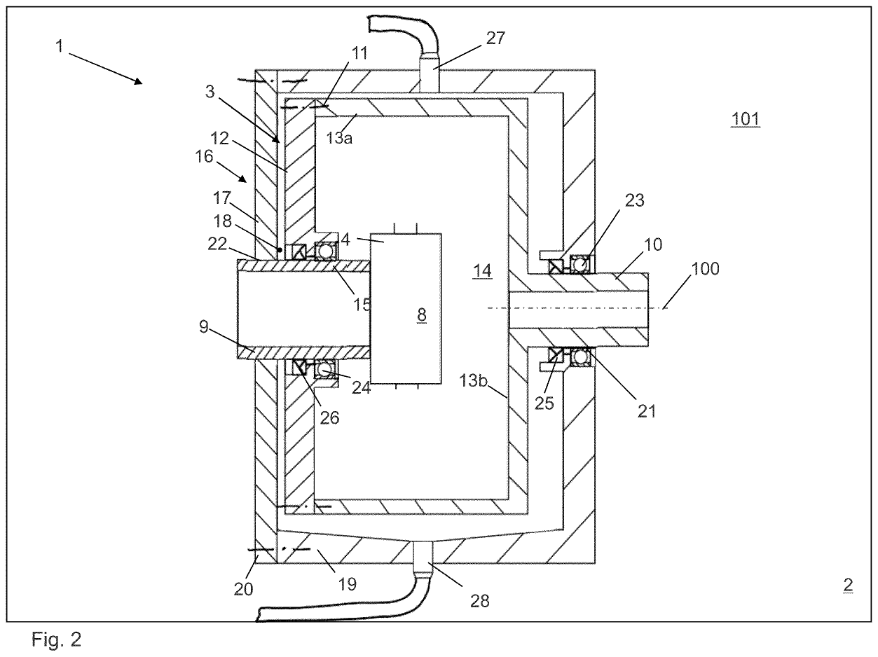

FIG. 2 shows the drum brake apparatus 1 in FIG. 1 with partially graphically hidden components of the brake drum device 3. In contrast, a fluid supply 27 is shown, which transports the cooling fluid into the fluid chamber 18, and a fluid discharge 28 is shown, which can transport the cooling fluid away out of the fluid chamber 18. The fluid supply 27 and the fluid discharge 28 are each designed as interfaces for pipes, channels, etc. The fluid supply 27 is located in an upper part of the drum brake apparatus 1, while the fluid discharge 28 is located in a bottom area, so that the cooling fluid can be guided through the drum brake apparatus 1 and in particular through the cooling device 16 or the fluid chamber 18 in a gravity-controlled manner.

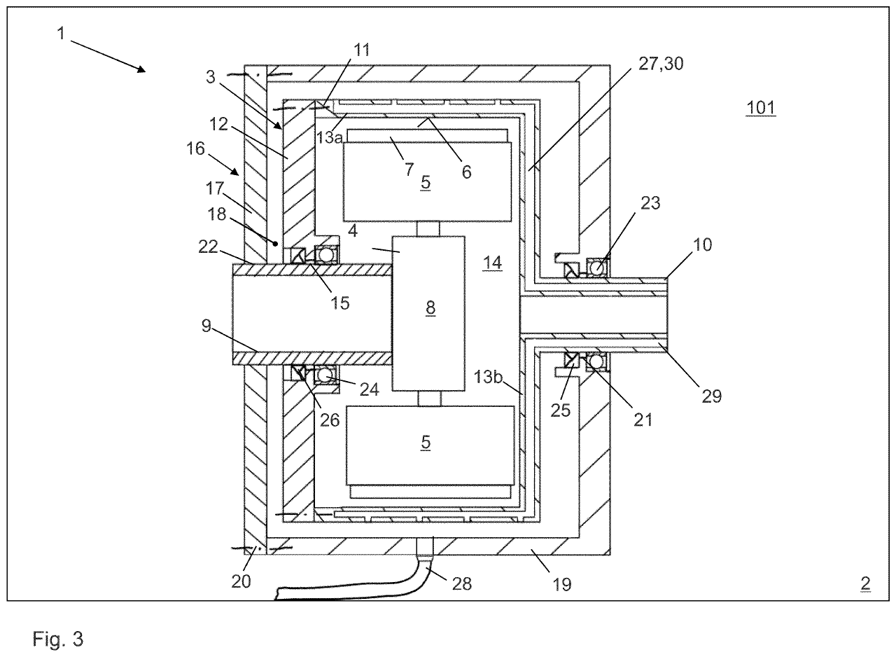

FIG. 3 shows a second embodiment as a drum brake apparatus 1. The same reference signs refer to the same parts or sections and only the differences are discussed below.

In this embodiment, the fluid supply 27 is designed differently. The fluid supply 27 is integrated into the connection shaft 10, which has an annular channel 29 running in the axial direction as the fluid supply 27. The fluid supply 27 merges into a double-walled region 30 of the brake drum 11, which forms a cooling jacket of the brake drum 11, and openings are provided on the outer circumference and/or on the radial outer side so that the cooling fluid can leave the brake drum 11 to reach the fluid chamber 18. The transporting away of the fluid can be implemented by the fluid discharge 28, as already described in FIG. 2.

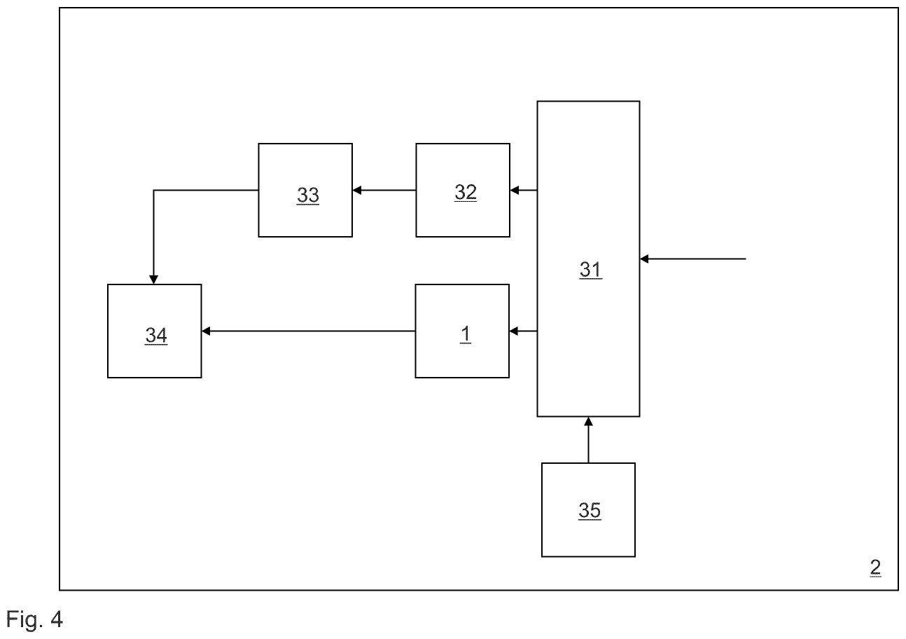

FIG. 4 shows a schematic block diagram of the electric vehicle 2, wherein the electric vehicle 2 has the drum brake apparatus 1 as previously described. Furthermore, the electric vehicle 2 has a thermal management arrangement 31, and the thermal management arrangement 31 is designed as a control device for the energy management. The electric vehicle 2 also includes a recuperation device 32 for recuperating kinetic energy into electrical energy, which can be stored in a battery 33. The battery 33 can be designed to supply the electric vehicle 2 with electrical energy for propulsion. Furthermore, the electric vehicle 2 includes at least one consumer 34, and the consumer 34 is designed as a heat source, for example for the interior as an interior heater, a window heater or the like. The electric vehicle 2 has a sensor system 35, which is designed, for example, as an outside temperature sensor system or as an inside temperature sensor system.

During operation of the vehicle 2, kinetic energy of the vehicle 2 must be dissipated in braking situations. The kinetic energy is distributed via the thermal management arrangement 31. For distribution, the thermal management arrangement 31 takes into account an outside temperature and/or an inside temperature. In the event that one or both temperatures are low, for example below 0°, kinetic energy from the drum brake apparatus 1 is allocated, so that heat energy is provided by converting the kinetic energy. This heat energy is made available directly to the consumer 34.

In the event that the temperatures are comparatively high, for example 20° C. or higher, the kinetic energy is provided to the recuperation device 32, which converts it into electrical energy and stores it back in the battery 33. If necessary, the electrical energy can be used to supply the consumer 34. However, it is clear from the block diagram that in the energy path via the recuperation device 32 the energy must be converted twice, namely once from kinetic energy into electrical energy and subsequently from electrical energy into heat energy. In contrast, with the energy path via the drum brake apparatus 1, the kinetic energy only needs to be converted into heat energy, which can then be made available directly to the consumer 34. The thermal management arrangement 31 thus manages to implement more efficient energy management for the electric vehicle 2.

### REFERENCE NUMERALS

1 Drum brake apparatus
2 Electric vehicle
3 Brake drum device
4 Brake device
5 Brake shoes
6 Braking surface
7 Friction lining
8 Brake actuator
9 Connection axle
10 Connection shaft
11 Brake drum
12 Brake drum cover
13a Radial wall
13b Drum base
14 Brake chamber
15 Inner axle passage opening
16 Cooling device
17 Cooling housing
18 Fluid chamber
19 Cooling pot
20 Cooling cover
21 Shaft passage opening
22 Outer axle passage opening
23 First bearing device
24 Second bearing device
25 First sealing device
26 Second sealing device
27 Fluid supply
28 Fluid discharge
29 Annular channel
30 Double-walled region
31 Thermal management arrangement
32 Recuperation device
33 Battery
34 Consumer
35 Sensor system
100 Main axis of rotation
101 Environment

1. A drum brake apparatus for an electric vehicle,
with a brake drum device, wherein the brake drum device includes a brake drum and forms a brake chamber, and
with a brake device, wherein the brake device has brake shoes and wherein the brake device is designed or arranged to press the brake shoes against an inner circumference of the brake drum in the brake chamber in order to generate a braking torque and to convert kinetic energy into heat energy,
with a cooling device for transporting away the heat energy via a cooling fluid,
wherein:
the cooling device forms a fluid chamber, wherein the cooling fluid is arranged in the fluid chamber and wherein the brake drum device is arranged in the fluid chamber, so that the brake chamber is arranged in the fluid chamber and is thereby arranged fluid-tight or dust-tight in relation to an environment.

2. The drum brake apparatus according to claim 1, wherein the drum brake apparatus is designed as a dry brake apparatus.

3. The drum brake apparatus according to claim 1, further comprising a connection axle for connecting the brake device to a stationary braking partner, wherein the brake drum device is mounted relative to the connection axle and is sealed fluid-tight via a first sealing device, wherein the brake drum device forms a first sealing partner and the connection axle forms a second sealing partner, so that the brake chamber is sealed fluid-tight and thus also dust-tight from the fluid chamber by the first sealing device.

4. The drum brake apparatus according to claim 3, further comprising a connection shaft for connecting the brake drum device to a rotating braking partner, wherein the connection shaft is mounted relative to the cooling device and is sealed fluid-tight via a second sealing device, wherein the cooling device forms a first sealing partner and the connection shaft forms a second sealing partner, so that the fluid chamber is sealed fluid-tight from the environment by the second sealing device.

5. The drum brake apparatus according to claim 4, wherein a theoretical brake dust path into the environment leads from the brake chamber via the first sealing device into the fluid chamber and subsequently via the second sealing device into the environment.

6. The drum brake apparatus according to claim 4, wherein the brake drum device has a a brake drum cover, wherein the brake drum and the brake drum cover form a drum housing for the brake chamber, wherein the brake drum is connected to the connection shaft in a rotationally fixed manner, wherein the drum housing is rotatably mounted via the brake drum cover relative to the connection axle and wherein the drum housing is designed to be statically fluid-tight except for the passage for the connection axle.

7. The drum brake apparatus according to claim 4, wherein the cooling device forms a cooling housing with the fluid chamber, wherein the cooling housing is arranged stationary with the connection axle and wherein the connection shaft is rotatably mounted relative to the cooling housing, wherein the cooling housing is designed to be statically fluid-tight in the direction of the environment except for the passage for the connection shaft.

8. The drum brake apparatus according to claim 1, wherein the cooling device has a fluid supply and a fluid discharge, wherein the fluid supply or the fluid discharge are designed as interfaces in the cooling device.

9. The drum brake apparatus according to claim 4, wherein the connection shaft has a fluid passage for the passage of the cooling fluid, wherein the fluid passage is fluidly connected to the fluid chamber.

10. An electric vehicle comprising the drum brake apparatus according to claim 1, with a consumer and with a thermal management arrangement, wherein the thermal management arrangement is designed to supply the kinetic energy of the drum brake apparatus for supplying the consumer with heat energy.

11. A drum brake, comprising:
a brake drum device forming a brake chamber and comprising a brake drum with an inner circumference;
a brake device comprising brake shoes, the brake device arranged to press the brake shoes against the inner circumference to generate a braking torque by converting kinetic energy into heat energy; and
a cooling device comprising:
a fluid chamber; and
a cooling fluid arranged in the fluid chamber for transporting the heat energy, wherein the brake drum device is arranged in the fluid chamber and fluid-tight relative to an environment.

12. The drum brake of claim 11, wherein the drum brake is a dry brake.

13. The drum brake of claim 11, further comprising:
a connection axle for connecting the brake device to a stationary braking partner; and
a first sealing device arranged for sealing the brake drum device to the connection axle to seal the brake chamber fluid-tight from the fluid chamber.

14. The drum brake of claim 13, further comprising:
a connection shaft for connecting the brake drum device to a rotating braking partner; and
a second sealing device arranged for sealing the cooling device to the connection shaft to seal the fluid chamber fluid-tight from the environment.

15. The drum brake of claim 14, wherein:
the brake drum device comprises a brake drum cover that, together with the brake drum, forms a drum housing for the brake chamber;
the brake drum is rotationally fixed to the connection shaft;
the brake drum cover is rotatably mounted to the connection axle; and
the drum housing is statically fluid-tight except for passage of the connection axle.

16. The drum brake of claim 14
the cooling device comprises a cooling housing;
the cooling housing is fixed to the connection axle;
the connection shaft is rotatably mounted relative to the cooling housing; and
the cooling housing is statically fluid-tight except for passage of the connection shaft.

17. The drum brake of claim 11, wherein the cooling device further comprises a fluid supply and a fluid discharge.

18. The drum brake of claim 14, wherein:
the connection shaft comprises a fluid passage for the cooling fluid; and
the fluid passage is fluidly connected to the fluid chamber.
